(19) United States
(12) Patent Application Publication
(10) Pub. No.: US 2018/0141655 A1
(43) Pub. Date: May 24, 2018

(54) VTOL airplane or drone utilizing at least two tilting propellers located in front of wings center of gravity.

(71) Applicant: Keith Wall, Arroyo Grande, CA (US)

(72) Inventor: Keith Wall, Arroyo Grande, CA (US)

(21) Appl. No.: 15/360,997

(22) Filed: Nov. 23, 2016

(51) Int. Cl. B64C 29/00; B64C 29/02; B64C 11/30; B64C 9/00; B64C 39/10

(52) U.S. Cl. CPC B64C 29/0033; B64C 29/02; B64C 2009/005; B64C 9/00; B64C 39/10; B64C 11/30

(57) ABSTRACT

A vertical take-off and landing aircraft or drone that has at least two tilting propellers mounted in front of the center of gravity of the wing. These tilting propeller are actively controlled and are capable of providing pitch, roll and yaw control throughout the flight envelop. This method of control can be applied to tilt wing or teal sitter aircraft, conventional or flying wing as well as other wing configuration for example box wing. In hovering flight the wing would be in the vertical position. The tilting propeller would provide pitch and yaw control. Roll control would be provided by differential thrust of the propellers. As the aircraft transitions to forward flight pitch control would be provided by tilting propeller. While yaw and roll control would be provided by a combination of tilting propellers and differential thrust. Upon complete transition to forward flight pitch and roll can be provided by telting propeller and or by a combination of aerodynamic control surfaces for example elevator ailerons or elevons depending on the wing configuration. While differential thrust could provide yaw and or rudder. Also throughout the flight envelop control surfaces can provide supplement control. The same process would be completed to transition to hovering flight.

### TECHNICAL FIELD

The present invention relates generally to VTOL aircraft or drone that utilizes at least two tilting propellers to provide pitch, yaw and roll control throughout the transition from vertical to forward flight and back to vertical flight. This could be applied to vertical or short takeoff and landing.

### BACKGROUND OF THE INVENTION

Traditional VTOL aircraft rely on ether cyclic controlled propellers, multiple propeller, and or aerodynamic devices that are located in the propeller's slipstream to provide pitch yaw and or roll control or a combination of these methods. This results in an aircraft that is either complex and expensive like the V-22 Osprey or worse with insufficient control in the transition phase from vertical to horizontal flight like the XC-142. Other methods have used multiple propeller that are used only in hover and transition to forward flight, upon conversion to forward flight they are stopped. In this stope state they contribute to additional drag on the aircraft.

### SUMMARY

The subject matter of the present application has been developed in response to the present state of the art, and in particular, in response to the problems and needs associated with conventional tilt-rotor, vertical-lift aircraft that have not yet been fully solved by currently available aircraft.”

### SUMMARY OF THE INVENTION

In the preferred embodiment the wing would have at least two tilting propellers that are actively controlled. They would be located in front of the wings center of gravity. The wing would have elevons that are located in the propeller's slipstream. These elevons would move in conjunction with the tilting propellers. For example if the aircraft is to pitch forward the propellers would tilt forward in relation to the wing while the elevons would rotate downward in relation to the wing. If the aircraft is to pitch rear word the propellers would tilt rearward in relation to the wing, while the elevons would rotate upwards.

In one embodiment the wings ailerons would be slaved to the tilting propellers. The ailerons would be of sized or located sufficiently outside of the propeller slipstream to have negligible effect on the pitching authority of the aircraft. They would be slaved to the tilting propeller in a way that when the propeller is rotated up words that the aileron would rotate down words and vice versa when the propeller is rotated downward the aileron would rotate upwards. This will allow the tilting propellers to provide pitch and yaw in hovering flight. Transition to pitch and roll in forward flight. This will allow the aileron to function as ailerons in forward flight in conjunction with tilting propellers providing pitch in addition to ether wing flaps or horizontal elevator. (In this embodiment the mechanism for example a servo would be mechanically linked to the tilting propeller. If the servo were to tilt the propeller forward the elaron would tilt up wordsand the that For example if the tilting propeller pitched forwared the)

In another embodiment pitch would be provided by the tilting propellers while yaw or roll would be provided by ailerons or wing flaps.

In another embodiment the wing would have multiple tilting propellers on each wing. The inboard propeller would control pitch while the outboard propeller would control yaw in hover transitioning to roll in forward flight. The tilting propeller would be slaved to the wing control surfaces. For example if the inboard propeller pitch forward the wing flaps would pitch down. If the outboard propeller pitch forward the ailerons would rotate upwards.

In another embodiment the aircraft would have multiple tilting propeller on each wing. Each propeller could be tilted independently as well as the wing flaps. For example if the aircraft were to desire to pitch forward all of the tilting propeller could be tilted forward. Now if it is desired to yaw the aircraft to the left while tilting forward the tilting propeller could all be positioned at different angles. For example the outboard propellers on the left wing could lesson there forward tilt while the inboard propellers could maintain their position as well as the tilting propeller on the other wing could maintain their position. The aircraft would yaw to the left.

In another embodiment of an aircraft with multiple propeller on each wing. Only the inboard propellers would tilt while the outboard propellers would be fixed. The inboard propeller would provide pitch while yaw or roll will be provided by the ailerons that will be in the slipstream of the fixed propellers at the tip of the wings.

In another embodiment of an aircraft with multiple propellers on each wing, only the outboard propellers would have the ability to tilt the inboard propeller would be fixed. The outboard propeller would provide pitch, yaw and or roll. While in hover the tilting propellers would provide pitch and yaw control, roll control would be provided by differential thrust as the aircraft transitions to forward flight pitch and roll would be provided by a combination of differential tilting and thrust, while in forward flight the aircraft's control surfaces could provide pitch, roll and yaw and or pitch and roll could be provided by tilting propellers while differential thrust could provide yaw.

In another embodiment tilting propeller could be used with wingeron function. In this embodiment pitch would be provided by tilting propeller yaw in hover would be provided by wingeron while roll would be provided by differential thrust. As the aircraft transitions to forward flight pitch would be provided by tilting propellers yaw and roll would be provided by a combination wingeron and differential thrust. In forward flight wingeron would provide roll pitch could be provided by control surfaces, wingeron and or tilting the propellers.

In another embodiment at least two tilting propeller are located on a wing surface. This wing surface is located at or near the center of gravity of the aircraft. The primary wing in forward flight is a boxed wing.

In another embodiment there are at least two tilting propeller that are located behind the wings center of gravity. In this configuration the tilting propeller are slaved to the elevons. The control mechanism that tilts the propeller will also rotate the elevons.

In another embodiment there are at least two tilting propellers that are located behind the wings center of gravity, they are not slaved to the elevons. The propellers and the elevons have separate tilting mechanisms this allows the elevons and propeller to tilt independently from each other

Box wing configuration propeller are mounted on a wing that is locate between the box wing at or near the center of gravity of the aircraft.

### BRIEF DESCRIPTION OF THE DRAWING

For a better understanding of the invention reference should be had to the following detailed description taken in conjunction with the drawings, in which:

FIG. 1 Show the basic configuration of a wing surface having tilting propellers located in front of the center of gravity of the wing. They are attached to the wing by means of a hinge.

FIG. 2 Wing surface with tilting propellers showing their position to cause a pitch up moment to the aircraft.

FIG. 3 Wing surface with tilting propellers with slaved ailerons.

FIG. 4 Tilt wing aircraft with tilting propellers and independent wing surfaces.

FIG. 5 Tilt wing aircraft with tilting propellers and slaved wing surfaces

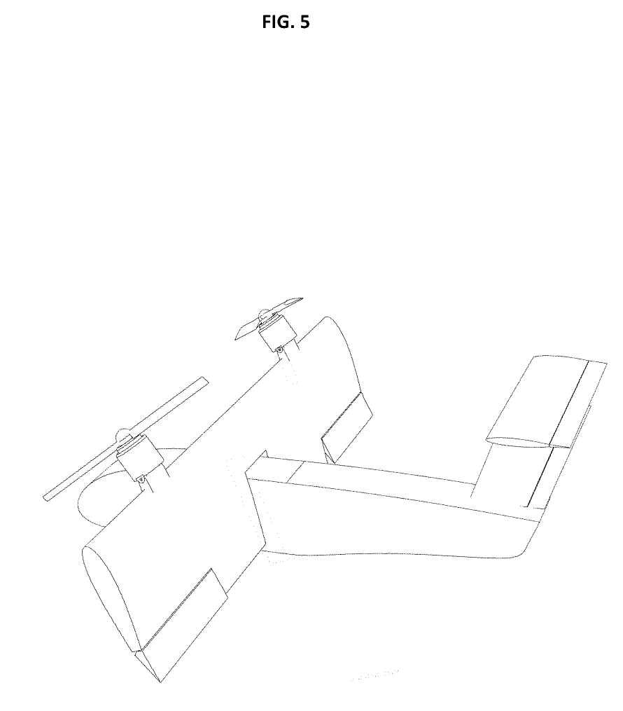

FIG. 6 Tilt wing aircraft with tilting propellers in a yaw configuration.

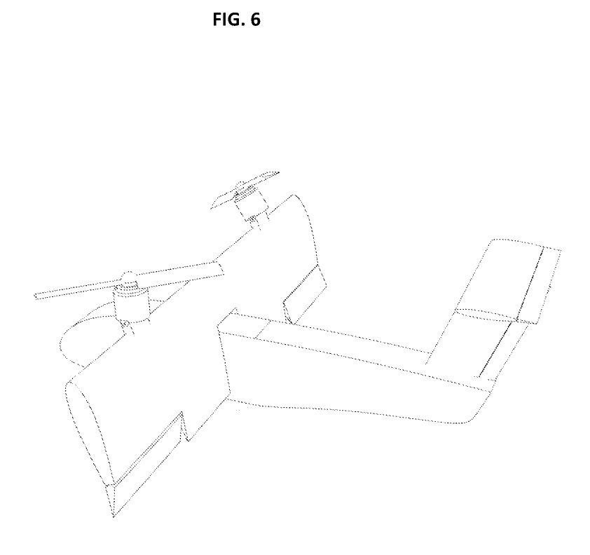

FIG. 7 Tell siting aircraft with tilting propellers and asymmetrical wing.

FIG. 8 Tell siting aircraft with tilting propellers asymmetrical wing and rotating vertical stabilizer.

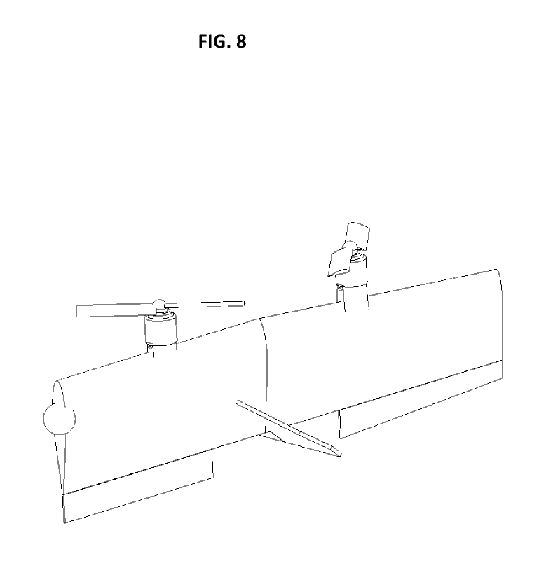

### DETAILED DESCRIPTION OF THE INVENTION

This VTOL aircraft has tilting propellers that are actively controlled view flight computer or mechanical mixer. They allow for an aircraft to take off vertical maintaining control throughout the flight envelop. By active control it is meant that there is means built in the aircraft to allow for the propellers to tilt for example by a hinge 7 that attaches the propeller assembly to the aircraft. There is also a means to move this propeller assembly for example a servo 15. Though any means that is capable of moving this assemble with speed and procession for example hydraulic, jack screw or other mechanical device.

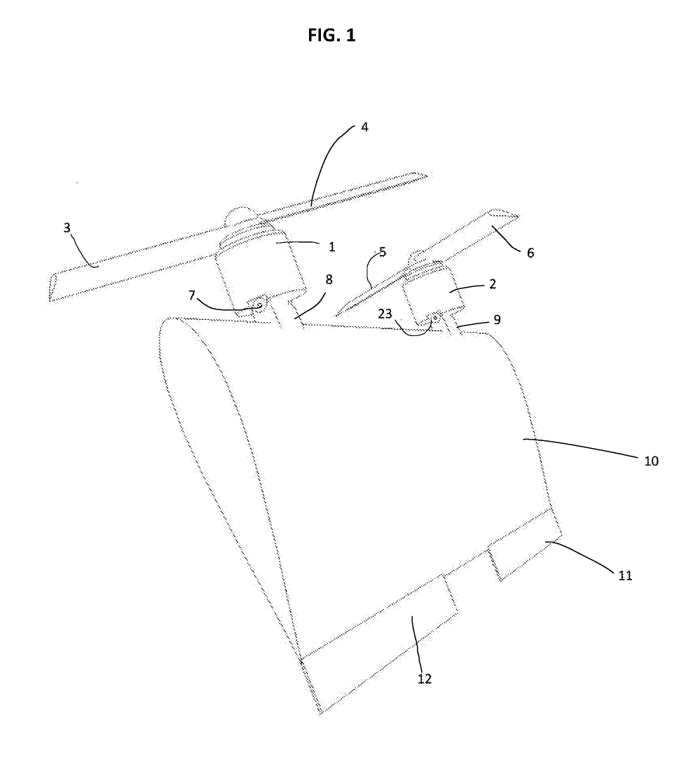

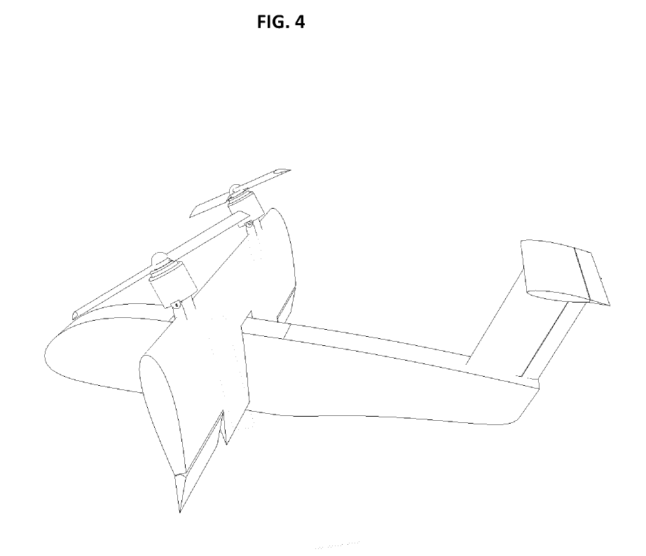

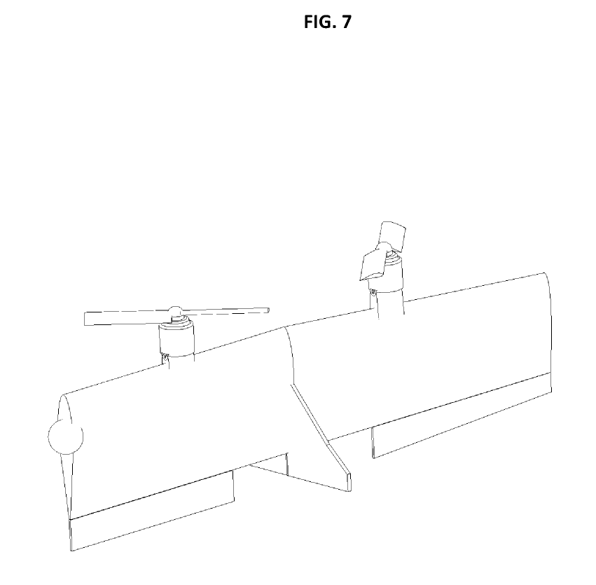

FIG. 1 shows the basic wing configuration regardless of the application. For example any configuration would have at least two actively controlled tilting propeller located in front of the wing surface of the for example. This wing could be located on a tiltwing aircraft FIG. 4 box wing aircraft other molt wing aircraft. Alternatively it be a tell siting aircraft like a flying wing FIG. 7. Regardless it will have at least 2 tilting propellers located on a wing surface.

The aircraft can be built using any known method for example composites, wood, or metal. Any one skilled in the art of manufacturing aircraft would be able to build such an aircraft. The tilting would be controlled by a flight computer that would move the propellers in the desired direction providing for stable controlled flight. Any flight controller computer could control the aircraft using a number of methods to control aircraft or drones. Any appropriate power source can be used to power the propellers as long as the propeller are able to pivot independently. For example they can be powered by individual motors or linked by mechanical shaft to at least one power source. Power source being defined as a means to provide rotary movement to the propellers. This could be any type of power source including turbo shaft, internal combustion engine, hybrid or electric. The propeller can be powered by individual motors or linked by mechanical shaft to at least one power source. Power source being defined as a means to provide rotary movement to the propellers. This could be any type of power source including turbo shaft, internal combustion engine, hybrid or electric.

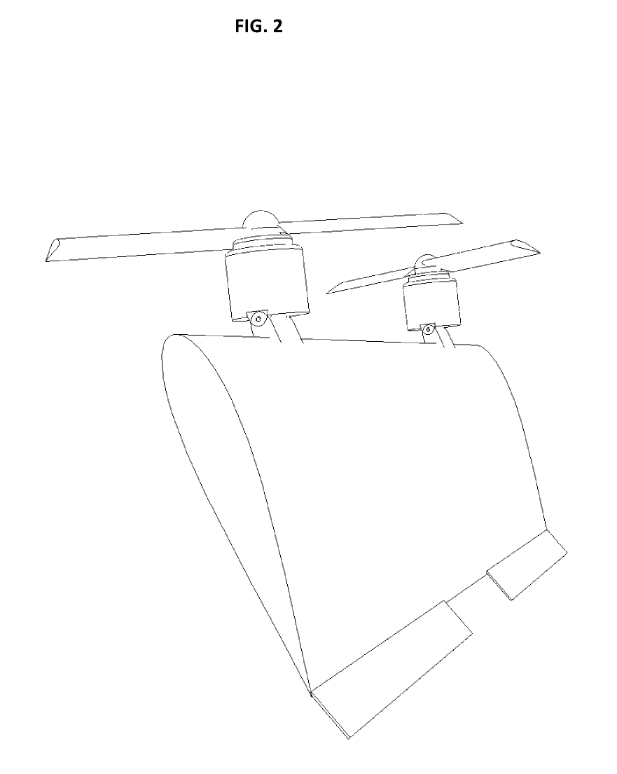

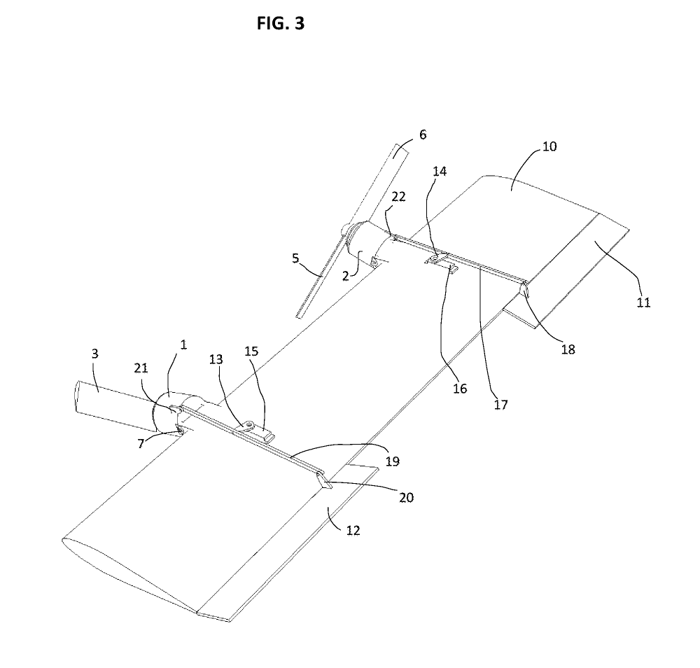

The wing 10 with the tilting propeller would have at least two tilting propeller 3,4 and 5,6 as in FIG. 1. A power means in this case electric motors 1 and 2 a hinge 7 and 23, a means to attach the hinge to the wing 8 and 9, trailing edge control surfaces 12 and 11. On some configuration for example multiple wing configuration the trailing wing surfaces could be optional. FIG. 2 show how the tilting propeller would work with the control surfaces to cause the aircraft to pitch up in this case the tilting propeller have rotated to a positive position as well as the wings control surfaces. In this configuration the tilting propeller and the wing surfaces can move independently of each other. For example is the aircraft were to be in hover and need to yaw left. Propellers 3 and 4 would pitch up while wing surface 12 would pitch down. At the same time propeller 4 and 6 would pitch down while with wing surface 11 would pitch up. This is demonstrated in FIG. 3.

FIG. 3 is of a simplified configuration where the propellers 5 and 6 are slaved to wing surface 11 while propellers 3 and 4 are slaved to wing surface 12. In this configuration if hover aircraft were to yaw right propellers 3 and 4 would tilt forwarded while the wing surface 12 would tilt up. Conversely propellers 5 and 6 would pitch back while wing surface 11 would pitch down. In these case the tilting propeller assembly and the move wing surface are physically linked by a rod 19 and 17. In this case the movement is provided by a servo 15 and 16 through a control arm 13 and 14 that are attached to pushrod 17 and 19.

FIG. 7 is of an asymmetrical configuration VTOL aircraft. This aircraft is capable of moving in a lateral direction at a high speed. The front while traveling laterally is the left side of the drawing having a round section containing the sincere package.

The invention claimed is:

1. An aircraft comprising having at least two tilting propellers located in front of the wings center of gravity. The tilting propellers are actively controlled providing pitch and yaw while the aircraft is in hovering flight and thought the flight envelop.

2. An aircraft in claim 1 having tilting propeller that are actively controlled. A flight computer or other mixing box would actively change the angel of the propellers thought the flight envelop. There will be provision for a form of servo, hydraulic or other mechanical mean to change the propeller tilt angel in relationship to the wing. These tilting propellers will mounted to a body that is attached to the wing by means of a hinge allowing for their controlled movement. The propellers could be driven by any means for example electric motor, drive shaft, any appropriate system that will provide rotational force.

3. An aircraft in claim 1 having tilting propellers that provide pitch while the aircraft is transition to forward flight. Yaw is controlled by a combination of differential thrust and differential tilt angels of the tilting propellers. While in forward flight the tilting propeller provide pitch, and roll while differential thrust provides yaw.

4. An aircraft in claim 1 has control surfaces that work with the tilting propellers and differential thrust to provide pitch, roll and yaw thought the flight envelop.

5. An aircraft in claim 1 has control surfaces that work with the titling propeller and differential thrust from hover. As the aircraft transitions to forward flight, tilting propellers are passed out as forward airspeed increases, transitioning control to the aircraft control surfaces.

6. An aircraft in claim one having control surfaces that are used for small adjustment while the tilting propellers provide large pitch changes. The control surfaces would be capable of rapid continues movements making fine adjustment where the tilting propellers would provide large pitch yaw or roll changes.

7. As the aircraft transition to forward flight the tilting propeller provide pitch while yaw is controlled by a combination of differential thrust and differential tilting angels of the tilting propellers. While in forward flight the tilting propeller provide pitch and roll while differential thrust provides yaw.

8. An aircraft in claim 1 having more than two propellers. This aircraft would have at least two tilting propellers that would provide pitch and yaw authority and roll as described in the other claims.

9. An aircraft in claim 1 having more than two propellers. All the propellers would have the capability to tilt.

10. An aircraft in claim 1 is a tilting wing aircraft. This is an aircraft with a fuselage and a tilting wing. The tilting wing would have at least two tilting propellers located in front of the wings center of gravity. This tilt wing would be located at or near the aircraft center of gravity. This aircraft could be of conventional layout with a vertical and horizontal stabilizer located at the rear of the fuselage. Alternatively this tilt wing aircraft could be of a flying wing type with no horizontal stabilizer located on the fuselage having only a vertical stabilizer on the fuselage or alternatively having no vertical stabilizer on the fuselage. This tilt wing aircraft could be of a multiple wing configuration for example a box wing. In this configuration, the tilt wing with tilting propeller is located at or near the aircraft center of gravity.

11. An aircraft in claim 1 is a tail setting aircraft having a wing with at least two tilting propellers. Such an aircraft will have provisions to seat on its tail. It could be of motiple wing configurations. In this configuration it is not necessary for the wing surface with tilting propellers to be located at the plains center of gravity.

12. An aircraft in claim 1 that is not capable of wing borne flight alone. Though in this configuration the wing with the tilting propellers would be of a size to supplement the lift provided by propellers but would have insufficient lift to maintain flight without the lift provided by the propellers. This aircraft could be a tail seater or tilt wing as described in claims 10 and 11.

13. An aircraft in claim one having deferential thrust by means of either controlling the pitch angel of the prop and or rotation speed of the propellers. In hovering flight, deferential thrust will provider roll as the aircraft transitions to forward flight deferential thrust in combination with deferential tilting of the propellers will provide both roll and yaw. With the complete transition to forward flight deferential thrust will provide yaw.

14. An aircraft in claim one tilting propeller provide pitch while the aircraft is transition to forward flight. Yaw is controlled by a combination of differential thrust and differential tilt angels of the tilting propellers. While in forward flight the tilting propeller provide pitch, and roll while differential thrust provides yaw.

15. An aircraft in claim 3 Differential thrust by means of increasing or decreasing rpm of the propeller

16. An aircraft in claim 3 Differential thrust by means of increasing or decreasing the pitch of the propellers.

17. An aircraft in claim 1 where the tilting propeller are slaved to the wings ailerons. In this configuration when a tilting pr

18. VTOL flying wing aircraft capable of flying laterally at high speed.

19. Aircraft in claim 18 having an asymmetrical wing allowing for stable high speed lateral flight.

20. Aircraft in claim 18 having a flying wing configuration with spit flap control surfaces that provided pitch as well as yaw stabilization.

21. Aircraft in claim 18 having a vertical stabilizer that is capable or rotating 180 degrees.

22. Aircraft in claim 18 having propeller with cyclic control.

23. Aircraft in claim 18 having tilting propellers.
